(19) United States
(12) Patent Application Publication
(10) Pub. No.: US 2017/0230637 A1
(43) Pub. Date: Aug. 10, 2017

(54) MULTIPLE CAMERA COMPUTING SYSTEM HAVING CAMERA-TO-CAMERA COMMUNICATIONS LINK

(71) Applicant: Google Inc., Mountain View, CA (US)

(72) Inventors: Chung Chun WAN, Fremont, CA (US); Choon Ping CHNG, Mountain View, CA (US)

(21) Appl. No.: 15/017,653

(22) Filed: Feb. 7, 2016

(51) Int. Cl. H04N 13/02; H04N 13/00

(52) U.S. Cl. CPC H04N 13/0271; H04N 13/0022

(57) ABSTRACT

An apparatus is described. The apparatus includes a first camera system having a processor and a memory. The first camera system includes an interface to receive images from a second camera system. The first camera system includes a processor and memory. The processor and memory are to execute image processing program code for first images that are captured by the first camera system and second images that are captured by the second camera system and that are received at the interface.

### BACKGROUND

A problem exists in traditional computing systems having one or more integrated cameras in that excessive amounts of image data are streamed up to the processing core of the computing system (e.g., one or more applications processors of a handheld device) in order for the processing core to process the image data and make intelligent decisions based on its content. Unfortunately much of the data that is streamed up to the processor is not relevant or of any interest. As such, significant amount of power and resources are expended essentially transporting meaningless data through the system.

### SUMMARY

An apparatus is described. The apparatus includes a first camera system having a processor and a memory. The first camera system includes an interface to receive images from a second camera system. The first camera system includes a processor and memory. The processor and memory are to execute image processing program code for first images that are captured by the first camera system and second images that are captured by the second camera system and that are received at the interface.

An apparatus is described. The apparatus includes means for processing at a first camera system images received by the first camera system. The apparatus also includes means for processing at the first camera system images received by a second camera system that are sent to the first camera system through a communications link that couples the first and second camera systems. The apparatus also includes means for notifying from the first camera system an applications processor of events pertaining to either or both of the first and second camera systems.

### FIGURES

The following description and accompanying drawings are used to illustrate embodiments of the invention. In the drawings:

FIG. 1 shows a first prior art dual camera arrangement;

FIG. 2 shows a second prior art dual camera arrangement;

FIG. 3 shows a third prior art dual camera arrangement;

FIG. 4 shows an improved dual camera arrangement;

FIG. 5 shows a method performed by a camera of the camera arrangement of FIG. 4;

FIG. 6 shows a computing system

### DETAILED DESCRIPTION

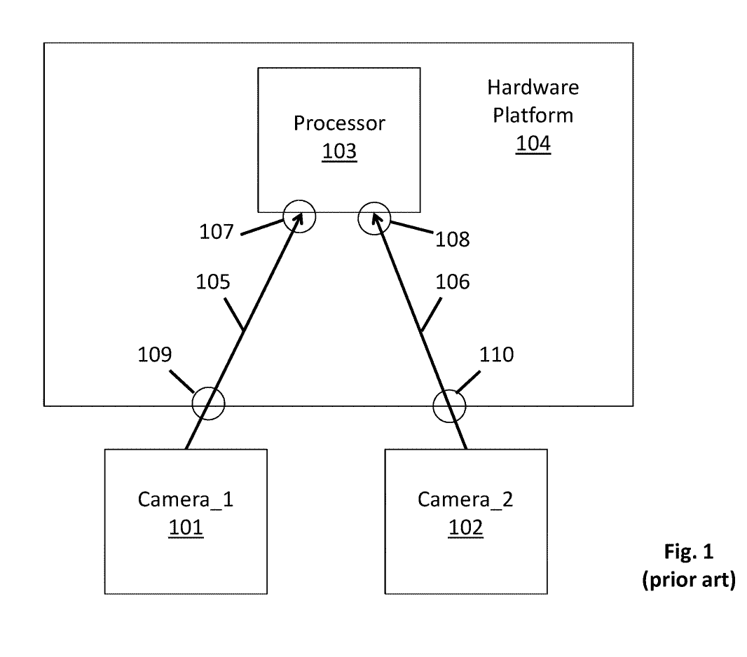

FIG. 1 shows a first prior art computing system having a dual camera arrangement in which two different cameras 101, 102 have separate respective hardware 105, 106 channels to an applications processor 103. According to the operation of the system of FIG. 1, the two cameras 101, 102 essentially direct their own dedicated image streams and other forms of communication independently to the processor through their respective channels 105, 106 across the hardware platform 104 of the system.

A problem with the approach of FIG. 1 is that twice the amount of overhead and wiring resides with the computer system as compared to a single camera solution. For example, if the first camera 101 desires to communicate to the processor 103, one or more signals are sent along channel 105 whereas if the second camera 102 desires to communicate to the processor 103, one or more signals are sent along channel 106.

The processor 103 therefore needs to be able to service two different communications at two different processor inputs 107, 108. (e.g., processor interrupt inputs) The consumption of two different processor inputs 107, 108 is inefficient in the sense that the processor 103 only has a limited number of inputs and two such inputs 107, 108 are consumed by the dual camera system. It may therefore be difficult to feed other direct channels from other components in the system (which may be numerous) which may be particularly troublesome if any components that cannot be designed to reach the processor directly are relatively important.

Another problem with the approach of FIG. 1 is the complex wiring density and associated power consumption. Here, consider a situation in which both cameras are simultaneously streaming to the processor 103 along their respective channels 105, 106. Both data streams are therefore separately transported through the hardware platform 104 to the processor.

Besides the inherent wiring complexity that naturally results from having two separate dedicated hardware channels 105, 106 designed into the hardware platform 104, there is also the problem of inefficient power consumption particularly if raw data or marginally processed image data is being directed to the processor 104 (i.e., the processor performs fairly complex functions on the data that is streamed from the cameras 101, 102). In this case, potentially, two separate streams of large amounts of data need to be transported over potentially large distances within the platform 104 which will require large amounts of power to effect.

Another problem with the approach of FIG. 1 is that the interfaces 109, 110 to the dual camera system is relatively inflexible. Here, the two cameras must connect to the pair of physical interfaces 109, 110 that are provided for them. That is, a designer of the hardware platform 104 is denied the opportunity of integrating cameras that do not support interfaces 109 and 110 and, likewise, the camera suppliers are denied the opportunity of integrating their cameras into the designer's platform 104.

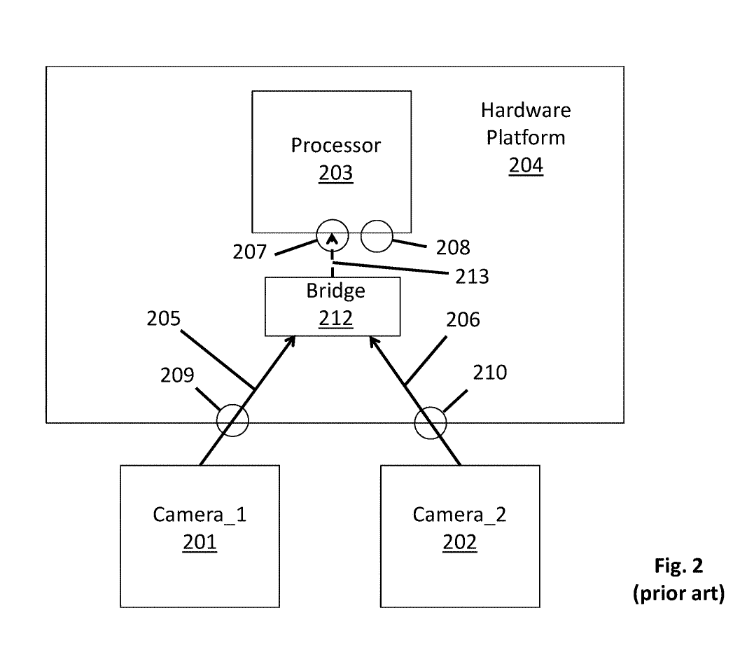

An improved approach, already known in the art, is observed in FIG. 2. According to the approach of FIG. 2, a bridge function 212 is placed between the dual camera system 201, 202 and the processor 203. The bridge function 212 essentially consolidates and/or multiplexes the communications from the two cameras 201, 202 (e.g., dual image streams, etc.) into a single channel 213 that is fed to the processor 203.

The introduction of the bridge function 212 helps alleviate some of the inefficiencies discussed above with respect to FIG. 1. In particular, only one input 207 is consumed at the processor which “frees up” an input 208 (as compared to the approach of FIG. 1) so that, e.g., some other system component other than a camera can directly communicate with the processor 203.

Power consumption is still a matter of concern, however. Here, the bridge function 212 is limited to multiplexing and/or interleaving and performs no substantial data reduction processes (such as data compression). As such, if large amounts of data are streamed up to the processor 203 then the hardware platform 204 will expend large amounts of power to transport large amounts of data over long distances within the platform 204.

Additionally, the bridge function 212 does not solve the problem of any mismatch that might exist between the type of interfaces 209, 210 that the platform 204 provides for connection to a camera and the type of interface that available cameras that might be an option for integration into the system have been designed to include.

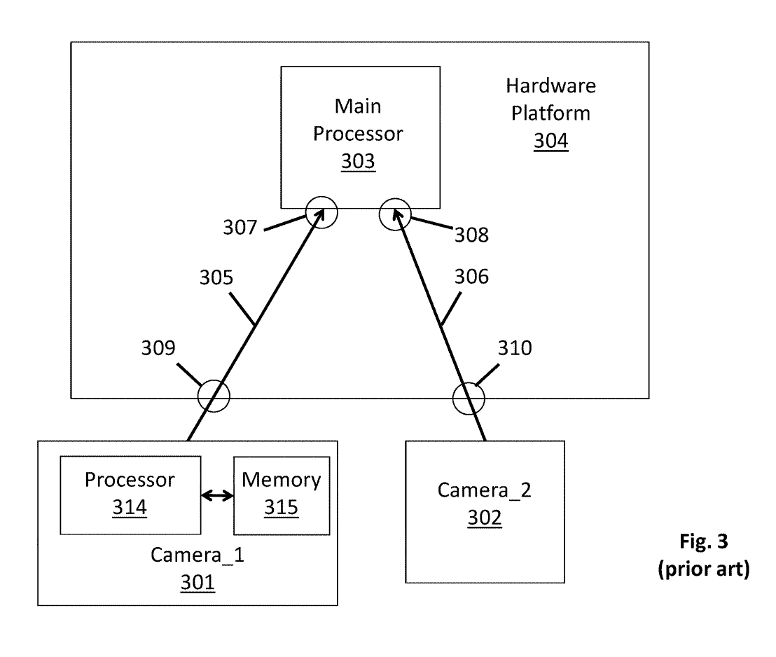

Referring to FIG. 3, the power consumption problem can be alleviated at least somewhat by introducing processing intelligence into one of the cameras. Here, FIG. 3 shows another prior art approach in which one of the cameras within a dual camera system (“primary” camera 301) has a local processor 314 and local memory 315. The processor 314 executes program code out of the memory 315 and can perform certain data size reduction functions, such as data compression, to effectively reduce the amount of data that needs to be transported up to the main processor 303.

With less data being sent to the main processor 303 (e.g., ideally, only the information that the main processor 303 needs to perform the image related applications that it executes is sent from the primary camera 301 to the main processor 303) the hardware platform 304 will consume less power without any loss of the functionality that the main processor 303 is supposed to provide.

Note, however, that the approach of FIG. 3, only includes one processor solution 314 in one of the cameras 301. Here, dual camera systems typically have a primary camera 301 and a secondary camera 302 (e.g., the secondary camera may be a “backside” camera that faces away from the user of a handheld device whereas the primary camera may be a “frontside” camera that faces the user of a hand held device (or alternatively the secondary camera may be the primary camera and the frontside camera may be the secondary camera). The lesser function of the secondary camera 302 typically does not justify the added cost of the processor 314 and memory 315 that is resident in the primary camera 301. As such, the power consumption reduction improvement of sending less data over the platform 304 to the main processor 303 is realized only for transfers from the primary camera 301 to the main processor 303 and not from the secondary camera 302 to the main processor 303.

Additionally, like the approaches of FIGS. 1 and 2, the hardware platform 304 of FIG. 3 provides a pair of fixed interfaces 309, 310 for the dual camera system. As such, the problem of mismatch between the interfaces 309, 310 that are supported by the hardware platform 304 and the interfaces designed into cameras that might otherwise be considered as candidates for integration into the platform 304 still exists. Further still, the approach of FIG. 3 consumes two processor inputs 307, 308 which, as discussed with respect to FIG. 1, may exclude other important components within the computing system from communicating with the main processor 303 directly.

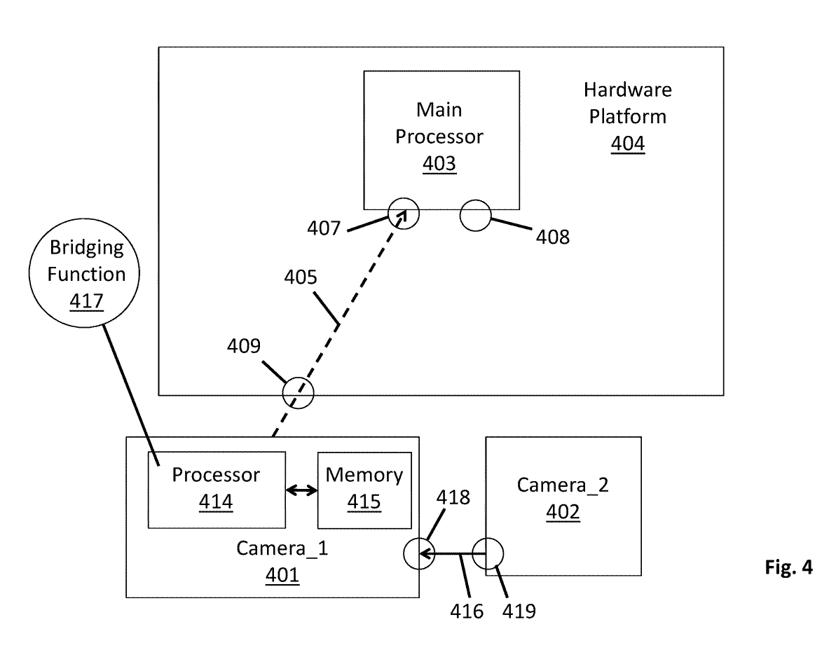

FIG. 4 shows a novel approach that overcomes the aforementioned problems better than any of the prior art solutions discussed just above with respect to FIG. 1 through FIG. 3. The approach of FIG. 4 includes a communication channel 416 between the secondary camera 402 and the primary camera 401. Also, a bridging function 417 is included in the primary camera 401 to, e.g., multiplex and/or combine image streams from both cameras 401, 402 through the single channel 405 that exists between the primary camera 401 and the main processor 403. As will be discussed in more detail further below, the channel 405 may be a direct hardwired channel or a logical channel that physically passes through multiple components of the hardware platform 404.

In the approach of FIG. 4, the image data from the second camera 402 is passed to the primary camera 401 over the communication channel 416 that exists between the two cameras 401, 402. The bridging function 417 that is embedded within the primary camera 401 (e.g., as an executable software program that the processor 414 executes) enables the primary camera 401 to send the secondary camera's image data as well as the primary camera's image data to the main processor 403 along channel 405.

Thus, like the approach of FIG. 2, the improved approach of FIG. 4 only consumes one input 407 at the main processor 403 which “frees up” a processor input 408 so that it can be used to communicate directly with some other component in the system.

Additionally, like the approach of FIG. 3, power savings are realized because data size reduction routines, such as data compression, can be performed by the primary camera 401 which reduces the total amount of data that needs to be transported through the platform 404 to the main processor 403. However, whereas the approach of FIG. 3 could only reduce power consumption for the primary camera 301 (i.e., only the size of the primary camera's image data could be reduced), the approach of FIG. 4 can reduce the associated power consumption of transporting information to the main processor 403 from both cameras 401, 402.

Here, the data reduction processes (e.g., data compression) performed by the primary camera 401 to its own image data can also be performed on the image data that it receives from the secondary camera 402 via channel 416. As such, smaller sized data streams from both cameras 401, 402 can be sent to the main processor 403.

Further still, the secondary camera 402 at least is indifferent to the particular type of camera interface 409 that has been implemented on the host hardware platform 404. Thus, only the primary camera 401 requires an interface that is compatible with an interface 409 of the platform 404. The secondary camera's interface 419 need only be compatible with the primary camera's second interface 418 for the solution to be implemented. Thus, the existence of the channel 416 between the primary and secondary cameras 401, 402 provides system designers with, potentially, more freedom of choice regarding the cameras that may be integrated with their platform 404.

For instance, as just one example, the channel 416 that resides between the cameras 401, 402 can be a proprietary channel of a camera manufacturer who manufactures both the primary and secondary cameras 401, 402. Even though the secondary camera 402 may not have an interface that is compatible with the host platform 404 it nevertheless is able to have its data streamed up to the main processor 403 via the camera-to-camera channel 416 and the bridging function 417 of the primary camera 401.

Additionally, the approach of FIG. 4 may be inherently more efficient for applications where images from the two cameras 401, 402 are combined or otherwise processed together to effect a cohesive singular set of information. One example is an implementation where the two cameras 401, 402 behave as a stereo pair and their respective images are combined to determine a three dimensional depth profile (“depth map”) of an object that both cameras 401, 402 are focused upon. The depth profile may be used by the main processor 403 to perform some image depth function (such as hand/finger motion detection, facial recognition, etc.).

Here, the software that is executed on the primary camera 401 may process its own image stream data and image stream data from the secondary camera 402 to compute the depth map. The depth map may then be sent from the primary camera 401 to the main processor 403. Here, previously known solutions required both image streams to be sent to the main processor 403. In turn, the main processor 403 performed the calculations to determine the depth map.

In the improved approach described just above where the depth map is calculated within the primary camera 401, substantial power savings are realized because only a depth map is transported across the platform 404 to the main processor 403 and the (potentially large amounts of) image stream data remain localized to the dual camera system 401, 402. Here, the depth map is understood to be a much smaller amount of data than the data of the image streams from which the depth map is computed.

Another example is auto-focusing. Here, depth profile information calculated from the image streams of both cameras 401, 402 by software that is executing on the primary camera 401 may be used to control an auto-focusing function for one or both cameras 401, 402. For instance, software executing on the primary camera 401 may process image streams from both cameras 401, 402 to provide control signals to voice coils, actuators or other electro-mechanical devices within one or both cameras 401, 402 to adjust the focusing positions of the lens system(s) of the camera(s) 401, 402.

As a point of comparison, traditional systems stream the image data to the main processor and the main processor determines the auto-focusing adjustments. In the improved approach that is capable of being performed by the improved system of FIG. 4, the main processor 403 simply receives focused image data (i.e., the main processor 403 does not have to perform various auto-focusing tasks). The reduced amount of data sent to the main processor 403 again corresponds to a power reduction improvement.

Other functions can also be performed by the software executing on the primary camera 401 to reduce the amount of information that is sent from the dual camera 401, 402 system to the main processor 403. Notably, in traditional systems, much of the information that is streamed to the main processor 403 is of little value.

For example, in the case of an image recognition function, large amounts of data without the looked for image are wastefully streamed up to the main processor 403 only to be discarded once the main processor 403 realizes that the image being looked for is not present. A better approach would be to perform image recognition within the primary processor 401 and only notify the main processor 403 once the looked for image has been recognized that the desired or looked for image is presently in view of the camera(s).

After the looked for item (or item of interest) is recognized by the primary camera 401, image data may then be streamed up to the main processor 403 so the processor can perform whatever function is to be performed subsequent to the desired image being identified (e.g., tracking the object, recording features around the object, etc.). As such, ideally, only information of relevance or interest (or information having a high probability of containing information of relevance or interest) is actually forwarded across the platform 404 to the main processor 403. Other information that does not contain items of relevance are ideally discarded by the primary camera 401.

Here, note that the looked for item of interest can be found in the primary camera's image stream or the secondary camera's image stream because the primary camera can process both streams. Depending on implementation, the standard for triggering notice to the main processor 403 that the item of interest has been found can be configured to identifying the item in both streams or just one of the streams.

The associated looked-for feature processes that are executed by the primary camera on the image streams of either or both of cameras 401, 402 may include, e.g., face detection (detecting the presence of any face), face recognition (detecting the presence of a specific face), facial expression recognition (detecting a particular facial expression), object detection or recognition (detecting the presence of a generic or specific object), motion detection or recognition (detecting a general or specific kind of motion), event detection or recognition (detecting a general or specific kind of event), image quality detection or recognition (detecting a general or specific level of image quality).

After the primary camera has detected a looked for item in an image stream it may also subsequently perform any of a number of related “follow-on” tasks to further limit the amount of information that is ultimately directed to the main processor 403. Some examples of the additional actions that may be performed by the primary camera include any one or more the following: 1) identifying an area of interest within an image (e.g., the immediate area surrounding one or more looked for features within the image); 2) parsing an area of interest within an image and forwarding it to other (e.g., higher performance) processing components within the system; 3) discarding the area within an image that is not of interest; 4) compressing an image or portion of an image before it is forwarded to other components within the system; 5) taking a particular kind of image (e.g., a snapshot, a series of snapshots, a video stream); and, 6) changing one or more camera settings (e.g., changing the settings on the servo motors that are coupled to the optics to zoom-in, zoom-out or otherwise adjust the focusing/optics of the camera; changing an exposure setting; trigger a flash).

Note that although FIG. 4 shows a direct channel 405 between the primary camera 401 and the main processor 403 the, complete end-to-end path between the primary camera 401 and the main processor 403 may be a direct hardware channel that terminates at the main processor 403 and/or may pass through a number of system functional blocks before reaching the camera. In one embodiment a direct hardware path exists from the primary camera 401 to an interrupt input of the main processor 403 for the purpose of notifying the main processor 403 of sudden events detected at the primary camera. Additionally, actual data may be forwarded to the system memory of the platform 404 (not shown) where it is subsequently read by the main processor 403.

In an embodiment, the interface that the primary camera actually plugs into may be provided by a peripheral control hub (not shown). The data from the primary camera may then be directed from the peripheral control hub directly to the processor or be stored in memory.

Software/firmware that is executed by the primary camera 401 may be stored in non volatile memory that is resident within the camera 401 or elsewhere on the platform 404. In the case of the later, the software/firmware is loaded from the platform to the primary camera 401 during system boot-up. Likewise, the camera processor 414 and/or memory 415 may be integrated as a component of the primary camera 401 or may be physically located outside the camera 401 itself but, e.g., placed very close to it so that is effectively operates as a processing system that is local to the camera 401. As such the instant application is more generally directed to camera systems rather than cameras specifically.

Note that either of cameras 401, 402 may be a visible light camera, a depth information camera (such as a time-of-flight camera that radiates infra-red light and effectively measures the time it takes for the radiated light to return to the camera after reflection) or a camera that integrates both visible light detection and depth information capture in a same camera solution.

Although the above discussion has focused on the execution of program code (software/firmware) by a camera system some or all of the above functions may be performed entirely in hardware (e.g., as an application specific integrated circuit or a programmable logic device programmed to perform such functions) or a combination of hardware and program code.

The interfaces between the primary camera 401 and the hardware platform 404 may be an industry standard interface such as a MIPI interface. The interfaces and/or channel between the two cameras may be an industry standard interface (such as a MIPI interface) or may be a proprietary interface.

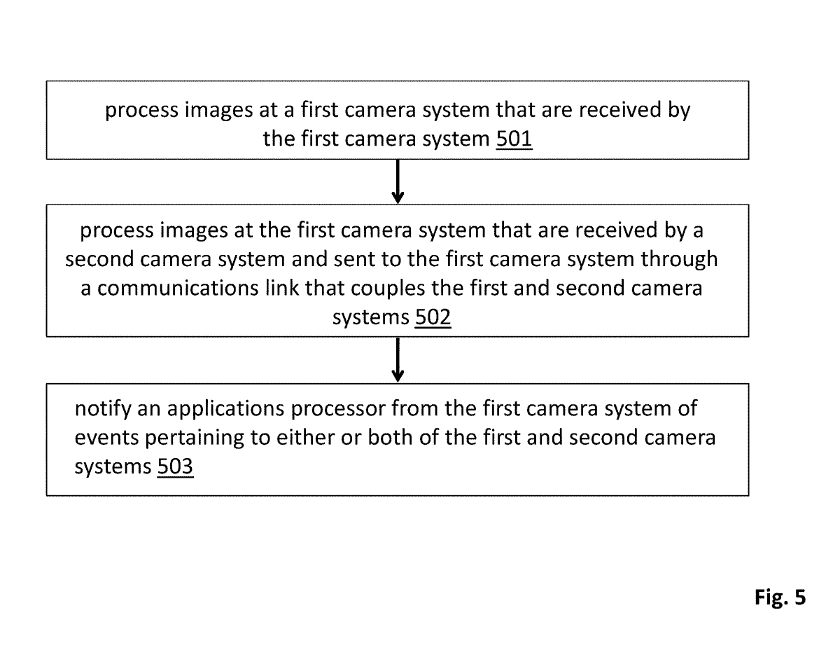

FIG. 5 shows a methodology described above that can be performed by a system having multiple cameras where a communication link exists between cameras. According to FIG. 5, the methodology includes processing images at first camera system that are received by a first camera system 501. The methodology also includes processing images at the first camera system that are received by a second camera system and sent to the first camera system through a communications link that couples the first and second camera systems 502. The methodology also includes notifying an applications processor from the first camera system of events pertaining to either or both of said first and second camera systems 503.

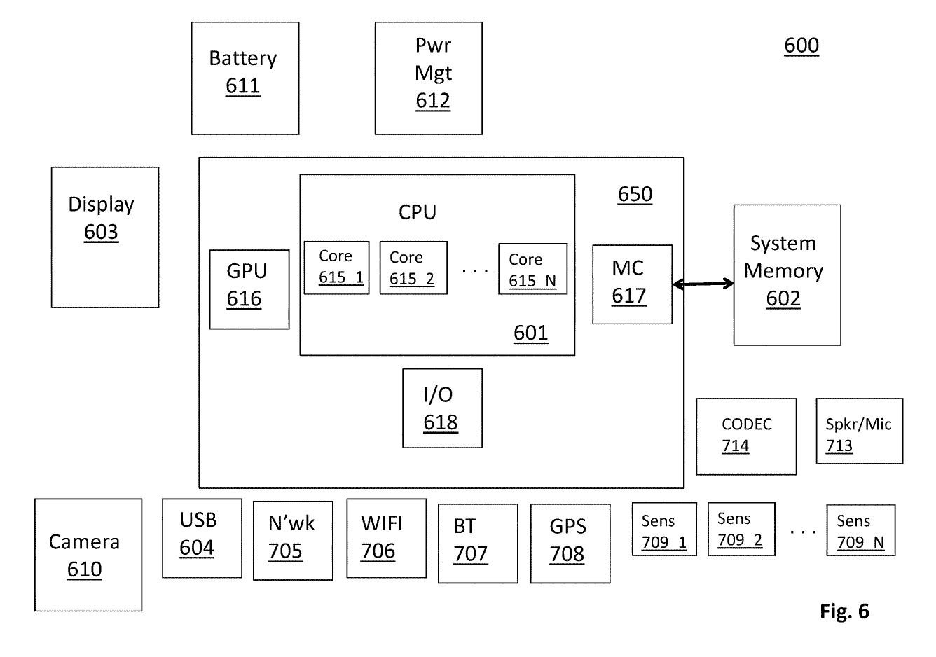

FIG. 6 provides an exemplary depiction of a computing system. Many of the components of the computing system described below are applicable to a computing system having an integrated camera and associated image processor (e.g., a handheld device such as a smartphone or tablet computer). Those of ordinary skill will be able to easily delineate between the two.

As observed in FIG. 6, the basic computing system may include a central processing unit 601 (which may include, e.g., a plurality of general purpose processing cores 615_1 through 615_N and a main memory controller 617 disposed on a multi-core processor or applications processor), system memory 602, a display 603 (e.g., touchscreen, flat-panel), a local wired point-to-point link (e.g., USB) interface 604, various network I/O functions 605 (such as an Ethernet interface and/or cellular modem subsystem), a wireless local area network (e.g., WiFi) interface 606, a wireless point-to-point link (e.g., Bluetooth) interface 607 and a Global Positioning System interface 608, various sensors 609_1 through 609_N, one or more cameras 610, a battery 611, a power management control unit 612, a speaker and microphone 613 and an audio coder/decoder 614.

An applications processor or multi-core processor 650 may include one or more general purpose processing cores 615 within its CPU 601, one or more graphical processing units 616, a memory management function 617 (e.g., a memory controller), an I/O control function (such as the aforementioned peripheral control hub) 618. The general purpose processing cores 615 typically execute the operating system and application software of the computing system. The graphics processing units 616 typically execute graphics intensive functions to, e.g., generate graphics information that is presented on the display 603. The memory control function 617 interfaces with the system memory 602 to write/read data to/from system memory 602. The power management control unit 612 generally controls the power consumption of the system 600.

Each of the touchscreen display 603, the communication interfaces 604-607, the GPS interface 608, the sensors 609, the camera 610, and the speaker/microphone codec 613, 614 all can be viewed as various forms of I/O (input and/or output) relative to the overall computing system including, where appropriate, an integrated peripheral device as well (e.g., the one or more cameras 610). Depending on implementation, various ones of these I/O components may be integrated on the applications processor/multi-core processor 650 or may be located off the die or outside the package of the applications processor/multi-core processor 650.

In an embodiment at least two of cameras 610 have a communication channel between them and one of these cameras has a processor and memory to implement some or all of the features discussed above with respect to FIG. 4.

Embodiments of the invention may include various processes as set forth above. The processes may be embodied in machine-executable instructions. The instructions can be used to cause a general-purpose or special-purpose processor to perform certain processes. Alternatively, these processes may be performed by specific hardware components that contain hardwired logic for performing the processes, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, FLASH memory, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

1. An apparatus, comprising:
a first camera system comprising a processor and a memory, said first camera system comprising an interface to receive images from a second camera system, said first camera system comprising a processor and memory, said processor and memory to execute image processing program code for first images that are captured by said first camera system and second images that are captured by said second camera system and that are received at said interface.

2. The apparatus of claim 1 wherein said image processing program code is to determine a depth map from said first and second images.

3. The apparatus of claim 1 wherein said image processing program code is to identify an item of interest.

4. The apparatus of claim 3 wherein said image processing program code is to discard images that do not contain said item of interest.

5. The apparatus of claim 1 wherein said image processing program code is to perform data compression.

6. The apparatus of claim 1 wherein both said first and second camera systems are able to capture visible images.

7. The apparatus of claim 6 wherein at least one of said first and second camera systems are able to capture depth profile information by time-of-flight techniques.

8. A computing system, comprising:
at least one applications processor;
a memory controller coupled to the at least one applications processor;
a system memory coupled to the memory controller;
a first camera system comprising a processor and a memory;
a second camera system;
a communication link between said first and second camera systems, wherein said processor and said memory of said first camera system are to execute image processing program code for first images that are captured by said first camera system and second images that are captured by said second camera system and that are sent to first camera system through said communication link.

9. The computing system of claim 8 wherein said first camera system sends information from both said first and second camera systems to said at least one applications processor.

10. The computing system of claim 8 wherein said first camera system is able to send an interrupt to said at least one applications processor based on processing of said first images and processing of said second images.

11. The computing system of claim 8 wherein said image processing program code is to determine a depth map from said first and second images.

12. The computing system of claim 8 wherein said image processing program code is to identify an item of interest.

13. The computing system of claim 12 wherein said image processing program code is to discard images that do not contain said item of interest.

14. The computing system of claim 8 wherein said image processing program code is to perform data compression.

15. A machine readable storage medium containing image processing program code that when executed by a first camera system deployed in a computing system causes a method to be performed, comprising:
process images received by said first camera system;
process images received by a second camera system and sent to said first camera system through a communications link that couples said first and second camera systems; and,
notify an applications processor of events pertaining to either or both of said first and second camera systems.

16. The machine readable medium of claim 15 wherein said image processing program code is to determine a depth map from said first and second images.

17. The machine readable medium of claim 15 wherein said image processing program code is to identify an item of interest.

18. The machine readable medium of claim 17 wherein said image processing program code is to discard images that do not contain said item of interest.

19. The machine readable medium of claim 15 wherein said image processing program code is to perform data compression.

20. The machine readable medium of claim 15 wherein said computing system is a handheld device.
